(19) United States
(12) Patent Application Publication
(10) Pub. No.: US 2017/0110710 A1
(43) Pub. Date: Apr. 20, 2017

(54) SELF-POWERED DEVICE PROVIDED WITH SELF-DESTRUCTION MEANS

(71) Applicant: COMMISSARIAT À L'ENERGIE ATOMIQUE ET AUX ENERGIES ALTERNATIVES, Paris (FR)

(72) Inventors: Lionel PICARD, Seyssinet-Pariset (FR); Johann LEJOSNE, La Cote St Andre (FR); Philippe AZAÏS, Saint-Egreve (FR); David DESCARSIN, Ballan (FR)

(73) Assignee: COMMISSARIAT À L'ENERGIE ATOMIQUE ET AUX ENERGIES ALTERNATIVES, Paris (FR)

(21) Appl. No.: 15/127,235

(22) PCT Filed: Mar. 17, 2015
(86) PCT No.: PCT/FR2015/050653

§ 371 Date: Sep. 19, 2016

(30) Foreign Application Priority Data
Mar. 18, 2014 (FR) 1400639

(51) Int. Cl. H01M 2/34; H01M 10/42

(52) U.S. Cl. CPC H01M 2/341; H01M 10/425; H01M 2010/4271

(57) ABSTRACT

The self-powered device includes a control circuit supplied by a power supply source, and self-destruction unit configured to destroy the device by impairing the power supply source. The invention also relates to the corresponding self-destruction method.

### BACKGROUND OF THE INVENTION

The invention relates to self-powered devices provided with a control circuit supplied by a power supply source, and destruction of which is performed by means of self-destruction means.

### STATE OF THE ART

It may be necessary to provide for self-destruction of self-powered devices provided with energy storage systems.

For example, in everyday life, a user may need to perform self-destruction of an object remotely if the latter has been stolen and contains confidential information. This is particularly true for high-technology objects, such as mobile phones, pads or laptop computers, which contain a large amount of personal or professional data.

In another field of application, it may be useful to activate remote explosion of a spacecraft at the end of life to limit the quantity of objects in orbit. For this purpose, explosive charges can be embarked, but this is very dangerous and may result in untimely explosion of the spacecraft. Furthermore, the heavier the spacecraft, the more expensive it is to place it in orbit. It is therefore advantageous to avoid embarking superfluous objects.

### OBJECT OF THE INVENTION

An object of the invention consists in proposing a lightweight, self-powered device which can self-destruct on command.

For this purpose, the device comprises a control circuit supplied by a power supply source, and self-destruction means configured to destroy the device by impairing the power supply source.

The self-destruction means can comprise a programmer configured to delay destruction of the device. They can also be activated remotely by means of a remote control system.

According to a first embodiment, the self-destruction means can be configured to cause an internal or external short-circuit of the power supply source.

In alternative manner, the self-destruction means can be configured to bring about charging of the power supply source beyond a critical threshold causing destruction of the power supply source.

The power supply source can further comprise an organic electrolyte, and the self-destruction means can comprise at least one heating element configured to increase the temperature of the organic electrolyte beyond its thermal runaway temperature.

According to an alternative embodiment, the self-destruction means can comprise a part configured to deform or pierce at least a part of the power supply source.

The invention also relates to a self-destruction method comprising the following steps:
providing a self-powered device comprising a control circuit supplied by a power supply source, and self-destruction means,
activating the self-destruction means,
destroying the device by impairing the power supply source.

### BRIEF DESCRIPTION OF THE DRAWINGS

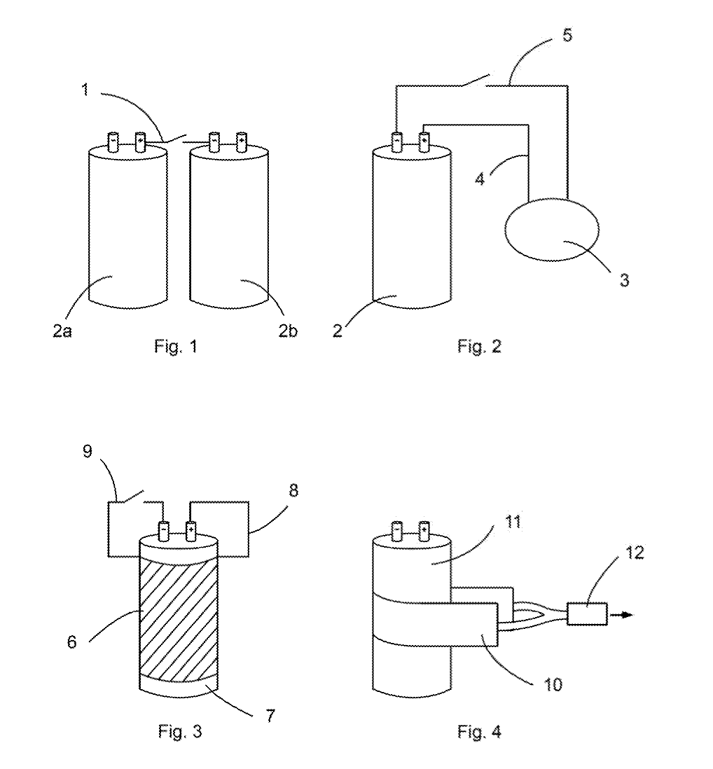

Other advantages and features will become more clearly apparent from the following description of particular embodiments of the invention given for non-restrictive example purposes only and represented in the appended drawings, in which FIGS. 1 to 5 illustrate in schematic manner five different embodiments of a self-powered device according to the invention.

### DETAILED DESCRIPTION

A self-powered device is generally provided with a power supply source configured to supply a control circuit and possibly other components. The power supply sources of devices designed for example for the public at large have known characteristics, in particular as far as their failure modes are concerned, i.e. under what conditions the power supply sources can be damaged.

One object of the invention is to take advantage of the failure modes of the power supply source to destroy the device. The latter is considered as being destroyed when it has become completely unusable and/or when the data it contains can no longer be retrieved. The device can for example be destroyed by explosion.

For this purpose, the device is provided with self-destruction means configured to impair the power supply source by mechanical and/or thermal, and/or electric actions. The power supply source is then used as destruction means of at least a part of the device. The object of destruction of the power supply source is to destroy another component of the device, for example a processor, a memory, or the mechanical integrity of the device in order to make the device non-functional even after the battery has been replaced.

The self-destruction means can be activated remotely by means of a remote control system which can for example be connected to the device by means of hard-wired or remote control means.

The self-destruction means can be provided with a programmer to enable the self-destruction time to be programmed. This is particularly useful for the user to have time to move away from the device when the self-destruction means are not able to be remotely activated.

According to a first embodiment, the self-destruction means are configured to cause a short-circuit of the power supply source.

According to the configuration illustrated in FIG. 1, the self-destruction means can comprise for example a switch 1 connected to a +pole of a first battery 2a and to a −pole of a second battery 2b, the two batteries 2a and 2b forming part of the power supply source. To destroy the device, a user activates the self-destruction means connected to the batteries 2a and 2b in series by closing the switch 1, and causes a local short-circuit in the power supply source.

Other ways of making a short-circuit in the power supply source can be envisaged. The short-circuit can be made in global manner, for example by using self-destruction means comprising a conducting plate able to be placed on the set of poles forming the power supply source (embodiment not represented).

In alternative manner, the self-destruction means can comprise a conducting liquid kept in a tank when the device is operating normally. This conducting liquid can for example be a metallic liquid such as Galinstan (Ga, In and Sn alloy preferably comprising 68.5% of gallium, 21.5% of indium and 10% of tin), NaK₂ or mercury. It can also be chosen from the family of peroxides so as to react with the electrolyte of the power supply source in exothermal reaction. When the self-destruction means are activated, the tank is emptied into the power supply source, which has the effect of connecting the poles and causing a short-circuit.

A short-circuit can also be achieved by melting of the insulating parts of the power supply source so as to bring the conducting parts of the power supply source into contact. For this, the self-destruction means can for example comprise heating means such as a conducting wire supplied by a secondary power source, this wire being positioned to heat the insulating parts of the power supply source when the self-destruction means are activated. In this embodiment, self-destruction of the device is performed more or less quickly according to the ability of the heating means to heat quickly, i.e. according to the power of the secondary or main power source.

Another approach using an electric failure mode of the power supply source can consist in charging the power supply source beyond a critical threshold.

According to the embodiment represented in FIG. 2, charging of the power supply source 2 beyond its nominal capacity can be performed by means of self-destruction means comprising a secondary power source 3, electric connections 4 and a switch 5.

When a user activates the self-destruction means, he causes closing of the switch 5 and the power delivered by the secondary power source 3 is then transmitted to the power supply source 2. The higher the power delivered by the secondary power source 3, the quicker the power source 2 exceeds its nominal capacity.

The secondary power source 3 can for example be a Li-ion battery, a thermal battery, a capacitor, etc. The secondary power source 3 can also comprise a conversion system for converting mechanical energy into electric power. For example, it can be in envisaged to use wind power to charge the power supply source beyond its nominal capacity. For example, if the device is able to fly and is in flight when it is required to be destroyed, a part of the air flux is collected to supply a conversion means of mechanical energy into electric power.

According to an alternative embodiment, the self-destruction means can comprise a control algorithm based on activation of relays or of mechanical assemblies configured to modify the electric connections in the power supply source, and to make its charge increase beyond a critical threshold or generate a short-circuit.

To cause a failure of the power supply source, it is also possible to act on its thermal properties.

When the power supply source comprises an organic electrolyte such as Li-ion or Li-primary, it may be useful to take advantage of the instability of these materials to cause thermal runaway of the power supply source and destruction of the latter. Self-destruction of the device is then achieved by immersion of at least a part of the memory and/or of the control circuit in the organic electrolyte.

The organic electrolyte can for example be chosen from the family of nitrile carbonates, lactones, amines, amides, and ether-oxides. It can also comprise a mixture of the above-mentioned compounds. The organic electrolyte is characterized by a thermal runaway temperature and an energy specific to each material.

According to the embodiment illustrated in FIG. 3, the self-destruction means comprise heating means 6 such as a thermo-resistive element surrounding a battery 7 belonging to the power supply source. The heating means 6 and battery 7 are connected by electric connections 8 and a switch 9. Thus, when the self-destruction means are activated, the switch 9 is placed in the closed position and the battery 7 provides power to the heating means 6 until the electrolyte contained in the battery 7 exceeds its thermal runaway temperature causing impairment of the power supply source.

In alternative manner, a heating element can be placed around each battery composing the power supply source. It can also be envisaged to use a secondary power source to supply the electric power to the heating element or elements. According to an alternative embodiment, the heating element can received energy by induction. The device can also be formed in such a way that the heating element is housed directly inside the power supply source.

To cause destruction of the device, the power supply source can also be impaired by a mechanical deformation such as a compression or an elongation. A mechanical deformation can be performed on any type of power supply source.

For example purposes as illustrated in FIG. 4, the self-destruction means can comprise a wire or a ribbon 10 placed around at least one battery 11 belonging to the power supply source. The self-destruction means also comprise a motor 12 able to exert a traction on the wire or ribbon 10, the motor being supplied by a secondary power source.

When the self-destruction means are activated, the motor 12 exerts a traction force on the wire or ribbon 10 to the extent of deforming the battery 11 and of making it unusable.

The motor 12 can for example be replaced by bias means such as a spring so that, in case of a shock, the bias means exert a sufficient traction on the wire or ribbon 10 to deform the battery 11.

A deformation of 10 to 20% of the volume of the power supply source enables explosion of the latter to be caused. In general, a deformation of 15% of the volume of the power supply source is sufficient.

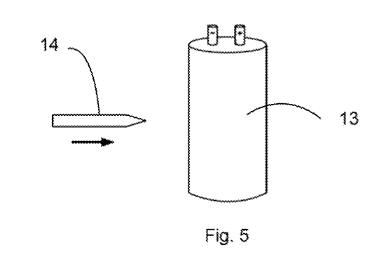

An alternative to mechanical deformation can be to pierce at least a part of the power supply source so as to cause an internal short-circuit. For example, according to the embodiment illustrated in FIG. 5, the power supply source comprises a battery 13 able to be pierced by an object 14. This embodiment can be combined with the embodiment represented in FIG. 4, for example by fixing the object 14 to the ribbon 10. In this way, when the self-destruction means are activated, the motor 12 exerts a traction on the object 14, and the latter transfixes the battery.

The object 14 can be embarked specifically to pierce the battery in case of self-destruction. It could also perform a function when the device is in use and be diverted from its primary use if the self-destruction means are activated.

According to a particular embodiment, the object 14 is conducting to enable both piercing of the battery and short-circuiting of the power supply source. The object 14 can also be sufficiently long to be able to pierce several batteries of the power supply source when the latter are positioned close to one another.

The advantage of performing mechanical deformation of at least a part of the power supply source is to cause leakage of the electrolyte to make the device unusable. For this, the batteries can comprise an area that is easily divisible designed to facilitate self-destruction of the device.

The present invention is not limited to the features that have been mentioned in the above. Electric, mechanical and thermal self-destruction means can be combined. In the case where several batteries form part of the power supply source, it is possible to cause a short-circuit on a first group of batteries, a mechanical deformation on a second group of batteries, and overheating of a third group of batteries.

It can also be provided to leave the choice of the failure mode up to the user. In this case, the self-destruction means can comprise different components in order to impair the power supply source by a mechanical and/or electric and/or thermal action. A selection algorithm then enables the user to choose from the different failure modes. This configuration can be useful in particular when the energy available to perform self-destruction is in small supply. In order to ensure that the device will be destroyed, the user can therefore choose the self-destruction mode that is the least energy-consuming.

1-27. (canceled)

28. Self-powered device comprising a control circuit supplied by a power supply source, and self-destruction means configured to destroy the device by impairing the power supply source.

29. Device according to claim 28, wherein the self-destruction means comprise a programmer configured to delay destruction of the device.

30. Device according to claim 28, wherein the self-destruction means are able to be remotely activated by means of a remote control system.

31. Device according to claim 28, wherein the self-destruction means are configured to cause a short-circuit of the power supply source.

32. Device according to claim 28, wherein the self-destruction means are configured to inject a conducting liquid connecting the two terminals of the power supply source.

33. Device according to claim 28, wherein the self-destruction means are configured to cause charging of the power supply source beyond a critical threshold causing impairment of the power supply source.

34. Device according to claim 33, wherein the power supply source comprises an energy storage system, and wherein the self-destruction means are configured to charge the energy storage system beyond a critical threshold.

35. Device according to claim 33, comprising a secondary power source and connection means between the power supply source and the secondary power source, and wherein the self-destruction means are configured to charge the energy storage system beyond a critical threshold by means of the secondary power source.

36. Device according to claim 33, wherein the self-destruction means are configured to perform modifications of the electric connections in the energy storage system.

37. Device according to claim 28, wherein the power supply source comprises an organic electrolyte, and wherein the self-destruction means comprise at least one heating element configured to increase the temperature of the organic electrolyte and to cause thermal runaway of the power supply source.

38. Device according to claim 37, wherein the heating element is a thermo-resistive element surrounding the power supply source.

39. Device according to claim 28, wherein the self-destruction means comprise means configured to crush at least a part of the power supply source.

40. Device according to claim 1, wherein the self-destruction means comprise means configured to pierce the power supply source.

41. Self-destruction method comprising the following steps:
providing a self-powered device comprising a control circuit supplied by a power supply source, and self-destruction means,
activating the self-destruction means,
destroying the device by impairing the power supply source.

42. Self-destruction method according to claim 41, wherein the activation step of the self-destruction means is delayed by a programmer.

43. Self-destruction method according to claim 41, wherein the activation step of the self-destruction means is performed remotely by means of a remote control system.

44. Self-destruction method according to claim 41, wherein the destruction step of the device is performed by short-circuiting the power supply source.

45. Self-destruction method according to claim 41, wherein the self-destruction means comprise a conducting liquid, and wherein the short-circuit is achieved by injection of the conducting liquid into the power supply source to connect its two terminals.

46. Self-destruction method according to any claim 41, wherein the power supply source comprises insulating parts and conducting parts, wherein the self-destruction means comprise a heating element supplied by a secondary power source, and wherein the short-circuit is achieved by melting of the insulating parts of the power supply source by the heating element.

47. Self-destruction method according to claim 41, wherein the destruction step of the device is performed by charging the power supply source beyond a critical threshold causing impairment of the power supply source.

48. Self-destruction method according to claim 47, wherein the self-destruction means comprise a secondary power source and connection means between the power supply source and the secondary power source, and wherein the destruction step of the device is performed by transmitting the energy from the secondary power source to the power supply source.

49. Self-destruction method according to claim 47, wherein the power supply source comprises an energy storage system, and wherein the self-destruction means are configured to charge the energy storage system beyond a critical threshold.

50. Self-destruction method according to claim 47, wherein the self-destruction means are configured to perform modifications of the electric connections in the energy storage system.

51. Self-destruction method according to claim 41, wherein the energy storage system comprises an organic electrolyte, and wherein the self-destruction means comprise at least one heating element, and wherein destruction of the device is performed by heating the organic electrolyte so as to cause thermal runaway of the power supply source.

52. Self-destruction method according to claim 51, wherein the heating element is a thermo-resistive element surrounding the power supply source.

53. Self-destruction method according to claim 41, wherein the self-destruction means comprise a ribbon partially surrounding the power supply source, and wherein destruction of the device is performed by traction of each end of the ribbon to deform at least a part of the power supply source.

54. Self-destruction method according to claim 41, wherein the self-destruction means comprise a foreign body, and wherein destruction of the device is performed by piercing at least a part of the power supply source.
